(19) United States
(12) Patent Application Publication
(10) Pub. No.: US 2019/0303608 A1
(43) Pub. Date: Oct. 3, 2019

(54) Data Protection Recommendations Using Machine Learning Provided as a Service

(71) Applicant: EMC IP Holding Company LLC, Hopkinton, MA (US)

(72) Inventors: Saar Cohen, Mishmeret (IL); Assaf Natanzon, Tel Aviv (IL)

(73) Assignee: EMC IP Holding Company LLC, Hopkinton, MA (US)

(21) Appl. No.: 15/944,121

(22) Filed: Apr. 3, 2018

(51) Int. Cl. G06F 21/62; G06F 3/06; G06F 17/30; G06F 15/18

(52) U.S. Cl. CPC G06F 21/6227; G06F 15/18; G06F 17/30964; G06F 3/067

(57) ABSTRACT

A data storage and protection service determines, based upon the characteristics of users and type of data, applicable regulatory requirements, internal policies and customs and practices of enterprises for storing and protecting data in external storage facilities, and advises enterprise users as to recommended storage locations and methodologies.

### BACKGROUND

This invention relates generally to enterprise data storage and protection, and more particularly to managing cloud data storage and protection to comply with changing regulatory requirements, industry requirements and practices, and enterprise policies that vary according to data characteristics such as data source, type and amount, industry, locations of generation and storage, etc.

Storage and data protection systems are capable of storing and protecting data in various formats, on various types of storage devices, with various types of protection, and for long periods of time. Frequently, data is subject to many different storage and protection requirements such as regulatory requirements set by governments, e.g., data security or privacy laws, control processes of organizations, e.g., the Securities and Exchange Commission (“SEC”) and the Internal Revenue Service (“IRS”), and particular requirements set by various other organizations. Different storage and protection requirements may apply based upon the type of data, its source, its content, its intended use, etc. Such requirements may be different between industries and verticals, between countries/states, and may continuously change over time. For example, medical records may be required to be retained for a long time, even up to 35 years in some countries. They are also subject to privacy and access restrictions defined by regulations such as HIPPA and similar regulations in other countries. The storage and protection system itself cannot determine the parameters for storing and protecting data, such as for how long and in what form, and is dependent on a user/operator of the system to use the appropriate policy and to specify for each data type the retention policy, access level, and other parameters to satisfy requirements.

Regulatory frameworks can guide enterprises or other organizations in storing and protecting data, but this framework is just the foundation. On top of this foundation, enterprises frequently develop their own set of storage and protection rules and policies based upon many different factors. These internal rules and policies may be based upon customs in the industry and long experience in protecting the organization's data, and they may have merely been passed down from one person to another with little or no explanation as to why they are used. In some cases the underlying reasons for the rules and policies may have changed or may have been forgotten. As a result, the internal rules and policies may become stale over time, as the data being backed up changes, the capabilities of the systems change, new systems are developed, and the economics of storing and protecting the data changes.

There are a number of challenges facing enterprises in maintaining current rules and policies for data storage and protection. As data and its uses evolve, its storage and protection needs also change. Cloud storage and protection systems are proliferating as a preferred way to store and protect data, making it difficult for a user to know the location where the data is stored or whether copies are being made, both of which may violate regulatory rules. Moreover, regulatory requirements and common practices in industries regarding data retention, protection, and security frequently change, making it practically impossible for organizations to update others and to receive updates from others as to current methodologies and practices. Thus, enterprises may be unintentionally violating regulations or failing to use the best and most cost effective practices.

It is desirable to provide systems and methods that address the foregoing and other problems in data storage and protection across multiple industries by automatically maintaining current regulatory information and updating enterprises in different industries on current regulatory requirements and the practices of others in their industries for storing and protecting data, and it is to these ends that the invention is directed.

### BRIEF DESCRIPTION OF THE DRAWINGS

FIG. 1 is a diagrammatic view illustrating an overview of the invention and its environment;

FIG. 2 is a diagrammatic view illustrating a cloud storage for multiple tenants of the cloud according to relevant factors and parameters applicable to data and tenants; and

FIG. 3 is a flowchart of a process in accordance with the invention for classifying a user and the user's backup data, and for advising the user as to recommended backup based upon the classifications.

### DESCRIPTION OF PREFERRED EMBODIMENTS

This invention is particularly applicable to enterprise data storage and protection systems in a multi-cloud environment, and will be described in that context. As will be appreciated, however, this is illustrative of only one utility of the invention, and the invention may be used in other contexts.

As described above, enterprise data storage and protection systems are subject to a wide variety of regulatory requirements, policies and customs and practices, which are evolving and changing over time. Furthermore, storage and protection system technology is rapidly evolving, and the economics and effectiveness of data storage and protection systems are constantly changing, as is the backed up data, as new technologies are being developed. As data and its uses evolve, the ways appropriate for its storage and protection also change. It is challenging for enterprise data processing administrators and users to remain current as to changing regulatory requirements, evolving technology, and changes to best practices in their industries. As organizations are moving to cloud storage, the traditional IT administrator may no longer be responsible for data copies in the cloud, but rather a cloud or an application administrator. This transition is another reason why organizations are losing knowledge. Additionally, data storage and protection cloud offerings are proliferating and becoming global, and more enterprises are backing up data to cloud storage and protection systems. Users and administrators may not be aware of the specific locations where their data is stored and whether the storage locations and systems comply with regulatory requirements that dictate where data may be stored and the format in which it must be stored. Since cloud providers service many different industries, which may have many different data storage and protection requirements, their storage and protection systems may not be appropriate for all types of industries and different types of data. Custom and practices in the relevant industry of the enterprise may also evolve to become more cost-effective and efficient, of which enterprise administrators and users may not be aware. Following such trends is very complicated because as new approaches continuously emerge, enterprise administrators need to be aware their maturity before shifting to them. They would also like to have an understanding of what the rest of their industry and market is doing, as this gives a good indication of what is working well and what is not.

The invention addresses the foregoing challenges by providing a method and system, referred to herein as a “service”, that is best suited to run at a central location such as on a service provider data processing center infrastructure or on a public cloud, that will determine compliance of the enterprise's storage and protection methodologies with internal and external requirements and current best practices, and that will work with an enterprise's data processing system backup software to advise the enterprise as to up-to-date customs, practices and trends. The service may, for example, track current protection methodologies of different enterprises by analyzing the types of enterprise data being backed up and how it is being protected, and may develop industry-specific, user-specific and data-specific profiles that characterize different types of industries users and data. The service may additionally track changes to regulatory requirements for different industries, different data types and even different source locations, and develop regulatory-specific profiles. When a user/subscriber to the service wishes to store and protect data, the service may classify the user and the particular data, and employ the various profiles to inform the user of what other similarly situated users are doing, and to provide a recommendation to the user as to the best approach for storing and protecting the data.

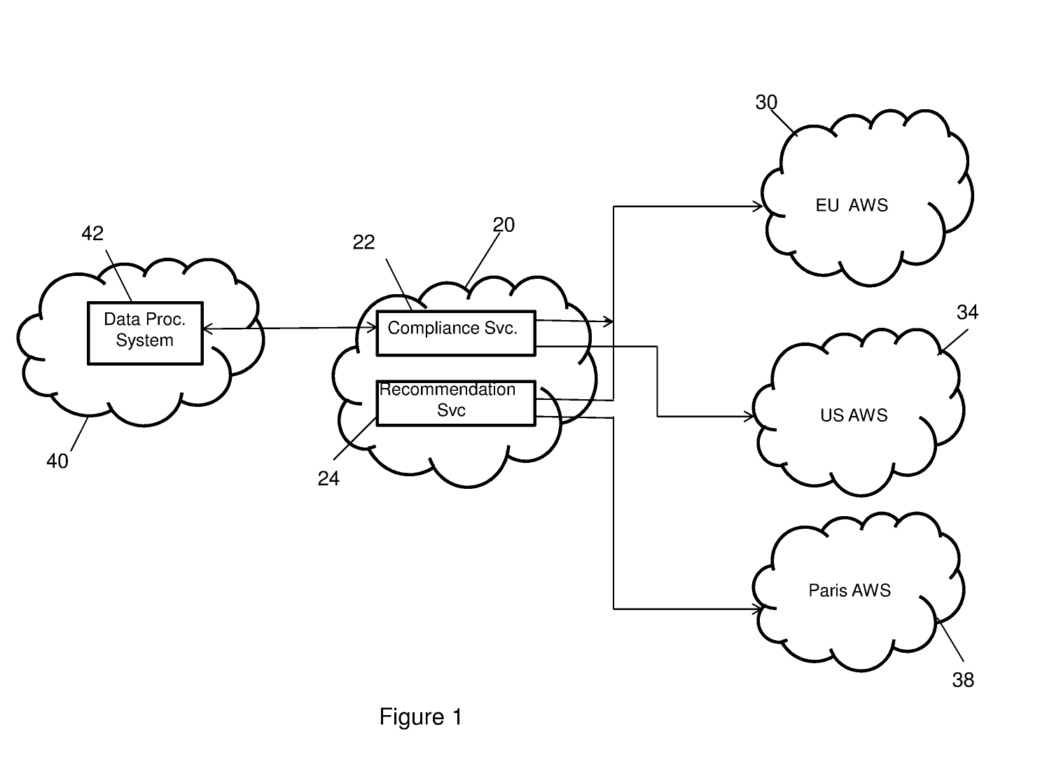

FIG. 1 illustrates an embodiment of the invention and an overview in the environment in which it may be employed. In the embodiment illustrated, the invention may comprise a service 20 referred to in this description as an “advisory service” running at a data center of a service provider, which may comprise a private cloud. The service may comprise a compliance service 22 and a recommendation service 24, which will be described in more detail below, running on one or more servers (not shown) of the service provider. The service may monitor multiple cloud-based storage and protection vendors having storage and protection systems in different geographical locations. These may include, for example, an IBM Bluemix cloud storage system 30 based in the EU, an AWS (Amazon) cloud storage 34 system based in the US, and an AWS cloud system 38 in Paris, among many others (not shown). Each of the cloud-based storage and protection vendors may provide data storage and protection systems for multiple different enterprises, in multiple different industries and in multiple different locations. As will be described in more detail, the service 20 may analyze and classify enterprise users based upon different factors and characteristics, such as, for example, industry, location, data type, internal and external storage and protection practices, among others, and use the results with other information to provide recommendations to an enterprise. If an enterprise 40 user of service 20 is located in the EU, for example, and enterprise's chief information officer (“CIO”) attempts to store data generated by the enterprise in AWS 34, this may be noncompliant with EU regulations which require EU source data to be stored in the EU. Accordingly, service 20 may advise that this is not compliant, and may notify the CIO that a new AWS cloud 38 has just been opened in Paris, of which the CIO may be unaware, and recommend that this cloud be used instead to store the data.

The enterprise user 40 of service 20 may comprise a data processing system 42 running at a data center of the enterprise or in a private cloud of the enterprise. The enterprise may select to backup and store data in one or more of the cloud storage systems 30, 34, 38. The particular cloud storage system used may be selected by an administrator or user of the data processing system based upon a number of different factors such as the type and source of the data or may be based upon established enterprise policies. The enterprise may have accounts on several of the cloud storage systems that permit the enterprise to specify different storage and protection conditions for different types of data and different use cases.

Enterprise 40 may subscribe to the service 20 to receive up to date information and recommendations for storing and protecting data of the enterprise. There may be multiple different enterprises as subscribers and users of service 20 (not shown in the figure), operating in many different industries, all having their own applicable internal and external storage and protection policies and requirements. The service may track the protection methodology of the enterprise subscribers that use it by analyzing the type of data being backed up and how it is being protected. The service should not track the actual data due to security concerns, but rather the metadata on the topology of the protection infrastructure, including where data is backed up, how many copies are retained, for how long, and using what technology for storage. Each enterprise may define to the service general information about its industry, location, and select a variety of different parameters that define their storage and protection needs including, for example, what storage, data protection and data management system to use (vendor, model, etc.); their policies with respect to data retention; and whether their policies are optimized for lower cost or for avoiding risk. Enterprises may additionally define specific data types they have, as defined in their industry, which may be similar to tags that they use in their storage, data processing and data management systems. These may be for instance, personal identification data, e.g., names, Social Security numbers, etc.; financial information, e.g., bank account numbers, credit card numbers, etc.; and medical records, e.g., test results, medical images, etc.

The service 20 may comprise computer executable instructions stored in computer readable media that control the operations of one or more server computers to perform the operations described herein. The service may provide an application programming interface (API) and a user interface (UI) which will allow a user to request recommendations such as the recommended policy for storing and protecting a particular data type, as used by other organizations, and to explore “what-if” scenarios as to how shifting to another methodology would affect cost and capabilities of protection. For instance, would a different protection methodology increase or reduce costs, and would it enable protecting more or less data. Additionally, an enterprise may obtain notifications as to the recommended method for protecting data based upon a particular enterprise's profile, and based upon changes in available cloud data centers and protection technologies.

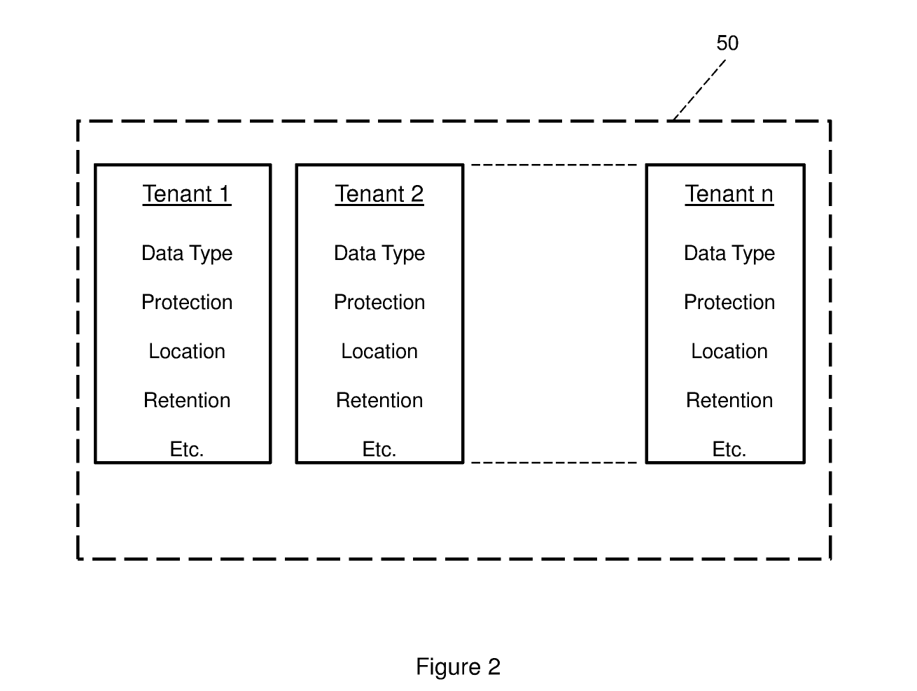

The service 20 may collect information from various enterprise subscribers that use the service for recommendations for selecting their protection methodology, and store the information in a database. FIG. 2 illustrates a database 50 for storing information from multiple subscribers to service 20. Each subscriber is a tenant of the database, and the database stores factors and parameters that characterize each tenant. As shown, this information may include, for each Tenant 1, Tenant 2 . . . Tenant n of the database, the data type(s), the protection methodologies employed, the tenant's location, etc. The service may employ machine learning techniques to deduce rules for storing and protecting data from the information stored for each tenant. For instance, the service may use the information to train a neural network to deduce a recommended cloud target based upon a set of input parameters such as the data type, customer location, amount of data and optimization target (cost/risk) and other relevant parameters and factors. As each new enterprise subscribes to the service, the neural network may be used to classify the new subscriber and provide a recommended cloud target location based upon its findings as well as recommended storage and protection parameters for the new enterprise. As new data enters the service, the models may be retrained and updated to reflect the current state of the art and usage patterns among tenants. The database may additionally store current usage recommendations for each enterprise tenant, and alert the tenant as the recommendations change based upon findings from new input information. Additionally, the service may determine the number of recommended copies of data for any given set of data characteristics and compliance requirements, and advise as to enterprise usage that diverts from pure regulatory requirements.

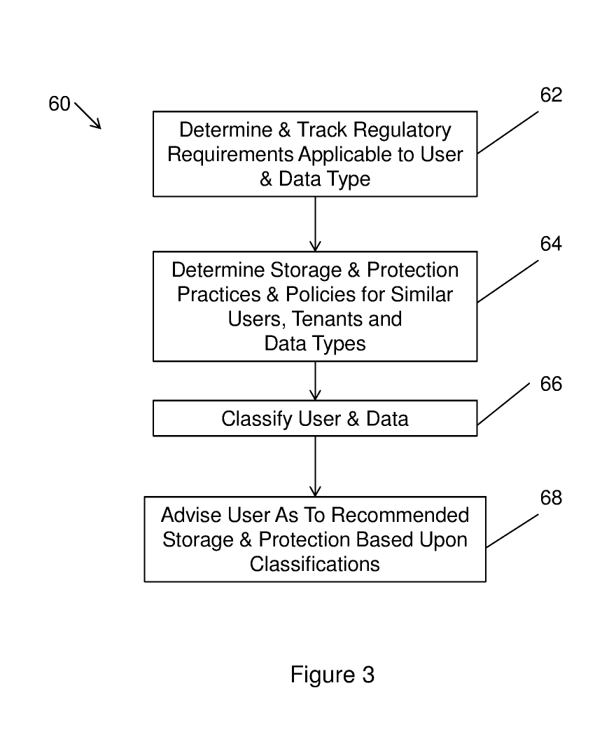

FIG. 3 is a block diagram illustrating an overview of a preferred embodiment of a method 60 in accordance with the invention for determining and advising an enterprise user as to recommended storage and protection methodologies and policies based upon the characteristics of the enterprise and the data being stored and protected. As indicated above, the method may be embodied in executable instructions that control one or more computer processors of service provider 20 to perform the various steps of the method.

Referring to the figure, at 62 the method may determine and track regulatory requirements applicable to different enterprise users and different data types based upon characteristics of users and the data. Relevant user characteristics may include, for instance, the industry or the vertical of the user, the user's status, and the user's location. Relevant data characteristics may include, for instance, data type, data source and storage location, data format and the use to which the data will be put. The service may track changes and updates to regulatory requirements by monitoring governmental sites responsible for issuing and enforcing the regulations and other sites in the relevant industries to which the regulations are applicable, and maintain current information as to requirements in database 50.

Method 60 may additionally at 64 determine and categorize storage and protection practices, policies and methodologies based upon industries and data types for users, tenants and data types of tenants in database 50. This information may be collected and maintained from the database tenants, as well as from other sources of available relevant information applicable to other similar users, tenants and data types, and stored in database 50 in relevant categories. The data may be collected, analyzed and categorized using machine learning to deduce applicable rules that characterize the user and the data. Upon receiving a request from a user subscriber to the service, at 66 the method may classify the user and the user's data into appropriate categories based upon the characteristics of the user and parameters applicable to the data.

Based upon the classifications determined at 66 and the information stored in the database at 62 and 64, the method at 68 may determine and advise the user as to recommended storage and protection methodologies. Where there are differences between the policies and storage and protection methodologies traditionally employed by the user and those currently employed by other similarly situated users or those required by changed regulations, the method can advise the user as to these differences to enable the user to make an informed decision as to an appropriate approach to use.

As may be appreciated from the foregoing, the invention affords a service that will enable data storage and protection users to be compliant with regulatory requirements, standard industry processes, and business needs by leveraging the collective wisdom of other users of the service. The service automatically learns from common usage practices and patterns that are similar to a tenant, and apply the learned knowledge by providing recommendations to users so that they may adjust their practices as the state of the art evolves to ensure that they store and protect their data in a cost effective and efficient manner.

While the foregoing has been with respect to particular embodiments of the invention, it will be appreciated by those skilled in the art the changes to these embodiments may be made without departing from the principles and the spirit of the invention, the scope of which is defined by the appended claims.

1. A method of storing and protecting data of a user, comprising:
determining and storing in a database internal policies applicable to the user and to the data for storing and protecting the data in an external data storage facility;
determining and storing in said database common storage and protection practices and policies applicable to different types of data and to a plurality of other different users;
deriving from said common storage and protection practices and policies using machine learning sets of rules and best practices applicable to storing and protecting said different types of data;
classifying the user and the user's data as to type; and
advising the user based upon said deriving and said classifying as to recommended storage and protection methodologies for said user data.

2. The method of claim 1 further comprising determining based upon an industry of said user and the type of said data, regulatory requirements applicable to storing and protecting said data.

3. The method of claim 2, wherein said advising comprises advising the user as to recommended storage and protection methodologies based upon said applicable regulatory requirements.

4. The method of claim 1, wherein said advising comprises advising as to applicable data retention policies and permissible numbers of copies of the data.

5. The method of claim 1, wherein said advising comprises advising as to said storage and protection methodologies based upon the type of said data.

6. The method of claim 1, wherein said determining said common storage and protection practices and policies comprises determining changes to said stored practices and policies, and updating said stored practices and policies with said changes.

7. The method of claim 1, wherein said advising comprises advising as to storing said data in a particular geographical location.

8. The method of claim 1, wherein said advising comprises advising to optimize one of cost of storing and lower risk.

9. The method of claim 1, wherein said advising comprises advising as to a data format for storing said data.

10. The method of claim 1, wherein said method is performed on a computer processor, and said deriving comprises analyzing information in said database using a machine learning process executed on said computer processor.

11. A computer product comprising non-transitory media for storing executable instructions for controlling a computer to perform a method of storing and protecting data of a user, comprising:
determining and storing in a database internal policies applicable to the user and to the data for storing and protecting the data in an external data storage facility;
determining and storing in said database common storage and protection practices and policies applicable to different types of data and to a plurality of other different users;
deriving from said common storage and protection practices and policies using machine learning sets of rules and best practices applicable to storing and protecting said different types of data;
classifying the user and the user's data as to type; and
advising the user based upon said deriving and said classifying as to recommended storage and protection methodologies for said user data.

12. The computer product of claim 11 further comprising determining based upon an industry of said user and the type of said data, regulatory requirements applicable to storing and protecting said data.

13. The computer product of claim 12, wherein said advising comprises advising the user as to recommended storage and protection methodologies based upon said applicable regulatory requirements.

14. The computer product of claim 11, wherein said advising comprises advising as to applicable data retention policies and permissible numbers of copies of the data.

15. The computer product of claim 11, wherein said determining said common storage and protection practices and policies comprises determining changes to said stored practices and policies, and updating said stored practices and policies with said changes.

16. The computer product of claim 11, wherein said advising comprises advising as to storing said data in a particular geographical location.

17. The computer product of claim 11, wherein said advising comprises advising to optimize one of cost of storing and lower risk.

18. The computer product of claim 11, wherein said advising comprises advising as to a data format for storing said data.

19. The computer product of claim 11, wherein said method is performed on a computer processor, and said deriving comprises analyzing information in said database using a machine learning process executed on said computer processor.
